(19) United States
(12) Patent Application Publication
(10) Pub. No.: US 2021/0062094 A1
(43) Pub. Date: Mar. 4, 2021

(54) A METHOD FOR PRODUCING A MIXTURE OF BIOHYDROCARBONS

(71) Applicant: Neste Oyj, Espoo (FI)

(72) Inventors: Risto VAPOLA, Porvoo (FI); Antti OJALA, Porvoo (FI)

(73) Assignee: Neste Oyj, Espoo (FI)

(21) Appl. No.: 17/046,178

(22) PCT Filed: Apr. 8, 2019
(86) PCT No.: PCT/FI2019/050280

§ 371 Date: Oct. 8, 2020

(30) Foreign Application Priority Data
Apr. 10, 2018 (FI) 20185342

(51) Int. Cl. C10G 3/00; C10G 45/26; C10G 69/06

(52) U.S. Cl. CPC C10G 3/50; C10G 45/26; C10G 2400/20; C10G 2300/1011; C10G 69/06

(57) ABSTRACT

A method for producing a mixture biohydrocarbons; an isomeric renewable paraffin composition for producing a mixture of biohydrocarbons; a mixture of biohydrocarbons containing propene and ethene; and use of the mixture of biohydrocarbons for producing chemicals and/or polymer.

### TECHNICAL FIELD

The present invention generally relates to a method for producing biohydrocarbons. The invention relates particularly, though not exclusively, to a method for producing biohydrocarbons by thermally cracking a hydrocarbon composition derived from a renewable feedstock.

### BACKGROUND ART

This section illustrates useful background information without admission of any technique described herein representative of the state of the art.

Steam cracking is an important method for producing chemicals from fossil hydrocarbons. The process is the main source of raw materials for conventional petrochemistry, and in particular polymer industry. The major polymers such as, for example, polyethene (PE), polypropene (PP), and polyethylene terephthalate (PET) are conventionally obtained from raw material produced by steam cracking fossil hydrocarbons. In Europe, typical steam cracker feeds are LPG (liquified or liquid petroleum gas) and fossil naphtha.

Examples of valuable products of a high severity fossil naphtha cracker are ethene and propene. Generally, ethene and propene makeup about 30 wt-% and 15 wt-% respectively of the product obtained from the conventional steam cracking process. Other valuable products include 1,3-butadiene and BTX (benzene, toluene, xylenes).

Replacing the conventional raw materials derived from fossil sources used in conventional petrochemistry and polymer industry with more sustainable raw materials is of increasing interest due to environmental considerations.

### SUMMARY OF THE INVENTION

It is an object of the present invention to provide an improved process for producing hydrocarbons from renewable sources, i.e. to produce biohydrocarbons. Particularly, it is an object of the present invention to provide a process with a high combined yield of ethene and propene. A further object of the present invention is to provide an alternative to existing technology.

According to a first aspect of the invention there is provided a method for producing a mixture of biohydrocarbons containing propene and ethene, the method comprising the steps of:
(a) providing a renewable isomeric paraffin composition containing monobranched isoparaffins and multiple branched isoparaffins, the ratio of the wt-% amount of the monobranched isoparaffins to the wt-% amount of the multiple branched isoparaffins being at least 1; and
(b) thermally cracking said renewable isomeric paraffin composition to produce a mixture of biohydrocarbons containing propene and ethene.

The current inventors have developed a process for producing biohydrocarbons resulting in a high combined ethene and propene yield. Ethene and propene are generally considered valuable products of a thermal cracking process. Surprisingly, it was found that using an isomeric hydrocarbon composition wherein the ratio of the wt-% amount of monobranched isoparaffins to the wt-% amount of multiple branched isoparaffins is at least 1 as the feed for thermal cracking promotes the formation of ethene and propene.

In an embodiment, providing the renewable isomeric paraffin composition comprises (i) preparing a hydrocarbon raw material from a renewable feedstock, and (ii) subjecting at least straight chain hydrocarbons in the hydrocarbon raw material to an isomerization treatment to prepare the renewable isomeric paraffin composition, wherein subjecting at least straight chain hydrocarbons in the hydrocarbon raw material to an isomerization treatment comprises controlling production of monobranched and multiple branched isoparaffins during the isomerization treatment. A renewable isomeric paraffin composition provided as in the embodiment described here before particularly promotes the formation of ethene and propene in the thermal cracking step.

In an embodiment, the pour point of the renewable isomeric paraffin composition is below 0° C., and the combined wt-% amounts of monobranched isoparaffins and multiple branched isoparaffins in the renewable isomeric paraffin composition is at least 45 wt-%. Increasing the amount of isoparaffins in the renewable paraffin composition decreases the temperature value of its pour point, i.e. improves the cold properties of the renewable paraffin composition. Improved cold properties allows processing, such as pumping, the renewable paraffin composition at a wider temperature range.

In an embodiment, the ratio of the wt-% amount of the monobranched isoparaffins to the wt-% amount of the multiple branched isoparaffins is at least 1.25, preferably at least 1.5, more preferably at least 1.75, and even more preferably at least 1.9. Increasing the ratio of the wt-% amount of monobranched isoparaffins to the wt-% amount of multibranched isoparaffins in the renewable paraffin composition increases the combined ethene and propene yield of the thermal cracking step.

In an embodiment, the renewable isomeric paraffin composition contains less than 40 wt-%, preferably less than 35 wt-%, more preferably less than 30 wt-%, and even more preferably less than 25 wt-% multiple branched isoparaffins. Decreasing the amount of multiple branched isoparaffins promotes the formation of ethene and propene during thermal cracking.

In an embodiment, the renewable isomeric paraffin composition contains at least 5 wt-%, preferably at least 30 wt-% monobranched isoparaffins. In an embodiment the monobranched isoparaffins are monomethyl substituted isoparaffins. Increasing the amount of monobranched isoparaffins in the renewable paraffin composition promotes the formation of ethene and propene during thermal cracking. Monomethyl substituted isoparaffins particularly promotes the formation of ethene and propene during thermal cracking.

In an embodiment, the renewable isomeric paraffin composition contains less than 65 wt-%, preferably less than 60 wt-%, more preferably less than 50 wt-% isoparaffins. In an embodiment, the isoparaffin content is no more than 49.5 wt-%, preferably no more than 49 wt-%, more preferably no more than 48.5 wt-%. It has been found that providing a renewable isomeric paraffin composition containing moderately isoparaffins promotes the formation of ethene and propene during thermal cracking and provides for appropriate cold properties.

In an embodiment, the renewable isomeric paraffin composition contains at least 10 wt-% n-paraffins. In an embodiment, the renewable isomeric paraffin composition contains at most 89 wt-% n-paraffins. In an embodiment, the renewable isomeric paraffin composition contains from 40 wt-% to 60 wt-%, preferably from 45 wt-% to 55 wt-% n-paraffins. Providing an isomeric paraffin composition containing moderately n-paraffins increases the combined ethene and propene yield in the thermal cracking step.

In an embodiment, the renewable isomeric paraffin composition contains preferably at least 90 wt-% paraffins, more preferably at least 95 wt-% paraffins, and even more preferably at least 99 wt-% paraffins. Increasing the paraffin content of the renewable isomeric paraffin composition promotes the formation of C2 and C3 hydrocarbons, such as ethene and propene, in the thermal cracking step.

In an embodiment, the mixture of biohydrocarbons contains more than 45 wt-%, preferably at least 50 wt-%, more preferably at least 53 wt-%, even more preferably at least 55 wt-%, most preferably at least 57 wt-% propene and ethene combined. A good combined yield of ethene and propene is desired, since propene and ethene are valuable products of the thermal cracking step.

In an embodiment, thermally cracking said renewable isomeric paraffin composition is conducted at a coil outlet temperature (COT) selected from the range from 780° C. to 890° C., preferably from 800° C. to 860° C., more preferably from 800° C. to 840° C., and even more preferably from 800° C. to 820° C. A particularly good combined ethene and propene yield is obtained using coil outlet temperatures selected from the ranges hereabove.

In an embodiment, preparing a hydrocarbon raw material comprises subjecting the renewable feedstock to a deoxygenation treatment, wherein the deoxygenation treatment is preferably hydrotreatment, more preferably hydrodeoxygenation; and/or hydrocracking hydrocarbons in the hydrocarbon raw material. Preparing the hydrocarbon raw material as in the embodiment described here before yields, after the isomerization step, a renewable isomeric paraffin composition that particularly promotes the formation of ethene and propene in the thermal cracking step.

In an embodiment, the renewable feedstock comprises at least one of vegetable oil, vegetable fat, animal oil, and animal fat. Renewable isomeric paraffin compositions prepared from said feedstocks particularly promotes the formation of ethene and propene during thermal cracking. In an embodiment, preparing a hydrocarbon raw material comprises subjecting the renewable feedstock to a hydrotreatment, preferably hydrodeoxygenation. In an embodiment, preparing a hydrocarbon raw material comprises hydrocracking hydrocarbons in the hydrocarbon raw material. Preparing the hydrocarbon raw material as in the embodiment described here before yields, after the isomerization step, a renewable isomeric paraffin composition that particularly promotes the formation of ethene and propene in the thermal cracking step.

In an embodiment, the renewable isomeric paraffin composition comprises at least one of a diesel range fraction and a naphtha range fraction and the diesel range fraction and/or the naphtha range fraction is subjected to thermally cracking said renewable isomeric paraffin composition to produce a mixture of biohydrocarbons containing propene and ethene. In an embodiment, only the diesel range fraction is subjected to said thermal cracking. In an alternative embodiment, only the naphtha range fraction is subjected to said thermal cracking. A particularly good combined ethene and propylene yield is obtained thermally cracking a renewable isomeric paraffin composition comprising at least one of the fractions mentioned hereabove.

In an embodiment, the renewable isomeric paraffin composition is selected from one of fractions A and B, wherein: fraction A comprises more than 50 wt-%, preferably at least 75 wt-%, more preferably at least 90 wt-% C10-C20 hydrocarbons, the content of even-numbered hydrocarbons in the C10-C20 range being preferably more than 50 wt-%, and the fraction A containing at most 1.0 wt-%, preferably at most 0.5 wt-%, more preferably at most 0.2 wt-% aromatics, and less than 2.0, preferably at most 1.0 wt-%, more preferably at most 0.5 wt-% olefins, and at most 5.0 wt-%, preferably at most 2.0 wt-% naphthenes; and fraction B comprises more than 50 wt-%, preferably at least 75 wt-%, more preferably at least 90 wt-% C5-C10 hydrocarbons, and the fraction B containing at most 1.0 wt-%, preferably at most 0.5 wt-%, more preferably at most 0.2 wt-% aromatics, and less than 2.0, preferably at most 1.0 wt.-%, more preferably at most 0.5 wt-% olefins, and at most 5.0 wt-%, preferably at most 2.0 wt-% naphthenes. Fractions A and B have been found to provide particularly desirable product distributions when thermally cracked.

In an embodiment, thermally cracking said renewable isomeric paraffin composition comprises steam cracking; and the steam cracking is preferably performed at a flow rate ratio between water and the renewable isomeric paraffin composition (H₂O flow rate [kg/h]/iso-HC flow rate [kg/h]) of 0.05 to 1.20, preferably of 0.10 to 1.00, further preferably of 0.20 to 0.80, more preferably of 0.25 to 70, even more preferably of 0.25 to 0.60 and most preferably of 0.30 to 0.50. In an embodiment, the thermal cracking is steam cracking. A particularly good combined ethene and propylene yield is obtained using the above flow rate ratios between water and the renewable isomeric paraffin composition.

According to a second aspect of the invention there is provided a renewable isomeric paraffin composition for producing a mixture of biohydrocarbons containing propene and ethene by thermal cracking, wherein the renewable isomeric paraffin composition contains monobranched isoparaffins and multiple branched isoparaffins, and wherein the ratio of the wt-% amount of the monobranched isoparaffins to the wt-% amount of the multiple branched isoparaffins is at least 1, preferably at least 1.25, more preferably at least 1.5, even more preferably at least 1.75, and most preferably at least 1.9; and wherein the combined wt-% amounts of the mono branched isoparaffins and the multiple branched isoparaffins in the renewable isomeric paraffin composition is preferably at least 45 wt-%; and wherein the pour point of the renewable isomeric paraffin composition is preferably below 0° C. The renewable isomeric paraffin composition of the second aspect is particularly well suited for thermal cracking, since it promotes the formation of ethene and propene during thermal cracking. Increasing the ratio of the wt-% amount of monobranched isoparaffins to the wt-% amount of multiple branched isoparaffins further promotes the formation of ethene and propene during thermal cracking of the renewable paraffin composition. A moderate amount of isoparaffins in the renewable isomeric paraffin composition improves its cold properties, i.e. decreases the temperature value of the pour point, thus allowing the renewable isomeric paraffin composition to be processed, e.g. pumped, at a wider temperature range.

In an embodiment, the renewable isomeric paraffin composition of the second aspect is provided as the renewable isomeric paraffin composition in the method according to the first aspect.

In an embodiment, the renewable isomeric paraffin composition contains less than 40 wt-%, preferably less than 35 wt-%, more preferably less than 30 wt-%, even more preferably less than 25 wt-%, and most preferably less than 20 wt-% multiple branched isoparaffins. A renewable isomeric paraffin composition containing a low amount of multiple branched isoparaffins is particularly well suited for thermal cracking, since it promotes the formation of ethene and propene during thermal cracking.

In an embodiment, the renewable isomeric paraffin composition contains at least 90 wt-% paraffins, preferably at least 95 wt-% paraffins, even more preferably at least 99 wt-% paraffins. A high paraffin content of the renewable isomeric paraffin composition promotes the formation of C2 and C3 hydrocarbons, such as ethene and propene, in the thermal cracking step.

In an embodiment, the renewable isomeric paraffin composition contains at least 5 wt-%, preferably at least 30 wt-% of monobranched isoparaffins. In an embodiment the monobranched isoparaffins are monomethyl substituted isoparaffins. A renewable isomeric paraffin composition containing a high amount of mono branched isoparaffins is particularly well suited for thermal cracking, since it promotes the formation of ethene and propene during thermal cracking. Monomethyl substituted isoparaffins particularly promotes promotes the formation of ethene and propene during thermal cracking.

In an embodiment, the renewable isomeric paraffin composition contains less than 65 wt-%, preferably less than 60 wt-%, more preferably is less than 50 wt-% isoparaffins.

In an embodiment, the isoparaffin content is no more than 49.5 wt-%, preferably no more than 49 wt-%, more preferably no more than 48.5 wt-%. A renewable isomeric paraffin composition containing moderately isoparaffins is particularly well suited for thermal cracking, since it has appropriate cold properties and promotes the formation of ethene and propene during thermal cracking.

In an embodiment, the renewable isomeric paraffin composition contains at least 10 wt-% n-paraffins. In an embodiment, the renewable isomeric paraffin composition contains at most 89 wt-% n-paraffins. In an embodiment, the renewable isomeric paraffin composition contains from 40 wt-% to 60 wt-%, preferably from 45 wt-% to 55 wt-% n-paraffins, more preferably from 50 wt-% to 55 wt-% n-paraffins. A renewable isomeric paraffin composition containing moderately n-paraffins is particularly well suited for thermal cracking, since it promotes the formation of ethene and propene during thermal cracking.

According to a third aspect of the invention there is provided a mixture of biohydrocarbons containing propene and ethene, the mixture being obtainable by the method according to the first aspect of the invention, wherein the combined amount of propene and ethene of the mixture of biohydrocarbons is preferably more than 45 wt-%, preferably at least 50 wt-%, more preferably at least 53 wt-%, even more preferably at least 55 wt-%, most preferably at least 57 wt-%.

According to a fourth aspect of the invention there is provided use of the mixture of biohydrocarbons according to the third aspect of the invention for producing chemicals and/or polymers, such as polypropene and/or polyethene. The current invention allows replacing hydrocarbons derived from fossil sources with hydrocarbons derived from renewable sources (biohydrocarbons), i.e. replacing hydrocarbons derived from fossil sources with more sustainable and environmentally friendly hydrocarbons.

Different non-binding example aspects and embodiments of the present invention have been illustrated in the foregoing. The embodiments in the foregoing are used merely to explain selected aspects or steps that may be utilized in implementations of the present invention. Some embodiments may be presented only with reference to certain example aspects of the invention. It should be appreciated that corresponding embodiments may apply to other example aspects as well.

### BRIEF DESCRIPTION OF THE DRAWINGS

Some example embodiments of the invention will be described with reference to the accompanying drawings, in which:

FIG. 1 shows a schematic picture of a laboratory scale steam cracking setup used in some of the Examples illustrating some embodiments of the current invention;

FIG. 2 shows a schematic picture of a pilot scale steam cracking setup used in some of the Examples illustrating some embodiments of the current invention;

FIG. 3 shows a schematic diagram of the effluent analysis performed in some of the Examples illustrating some embodiments of the current invention;

FIG. 4 shows reference components for GC×GC analysis.

### DETAILED DESCRIPTION

As used herein, the term “comprising” includes the broader meanings of “including”, “containing”, and “comprehending”, as well as the narrower expressions “consisting of” and “consisting only of”.

It is generally known that “ethene” and “ethylene” refer to the same compound C₂H₄. Hence, the terms “ethene” and “ethylene” are interchangeable names of the same compound, and used as such in the present description.

It is generally known that “propene” and “propylene” refer to the same compound C₃H₆. Hence, the terms “propene” and “propylene” are interchangeable names of the same compound, and used as such in the present description.

The term “biohydrocarbon”, or “biohydrocarbons”, refers as used herein to a hydrocarbon compound, or hydrocarbon compounds, obtained or derived from renewable feedstock.

As used herein “renewable isomeric paraffin composition” refers to a composition derived from a renewable feedstock or renewable source or sources, the composition mainly containing paraffins, and comprising isoparaffins. The term “isomeric paraffin composition” refers, as used herein, to said renewable isomeric paraffin composition.

As used herein, the term “diesel range fraction” refers to a fraction or composition having a boiling point ranging from 180 to 360° C. measured according to EN-ISO-3405 (2011). As used herein, the term “naphtha range fraction” refers to a fraction or composition having a boiling point ranging from 30 to 180° C. measured according to EN-ISO-3405 (2011).

As used herein, “paraffin content” is the combined wt-% amounts of n-paraffins and isoparaffins. As used herein, “isoparaffin content” is the combined wt-% amounts of monobranched isoparaffins and multiple branched isoparaffins.

The “isomerization degree” is used herein to refer to the amount of isomerized paraffins relative to total paraffin content in a composition. Said amount may be expressed in wt-%.

Renewable Isomeric Paraffin Composition

The renewable isomeric paraffin composition of the present invention contains isoparaffins (i-paraffins) and normal paraffins (n-paraffins). The isomeric paraffin composition has preferably a high paraffin content, since a high paraffin content promotes a high yield of C2 and C3 hydrocarbons, such as ethene and propene, in the thermal cracking step. C2 and C3 hydrocarbons are generally considered valuable products of the thermal cracking step. Thus, the isomeric paraffin composition comprises preferably at least 90 wt-% paraffins. More preferably, the isomeric paraffin composition comprises at least 95 wt-% paraffins. Most preferably, the isomeric paraffin composition contains at least 99 wt-% paraffins.

The isoparaffins of the isomeric paraffin composition comprises monobranched isoparaffins and multiple branched isoparaffins. Monobranched isoparaffins are paraffins, or alkanes, having one sidechain or branch. Multiple branched isoparaffins, also referred to as multibranched isoparaffins, are paraffins, or alkanes, having at least two sidechains or branches. Said multiple branched isoparaffins may have two, three, or more sidechains, or branches. In a preferred embodiment, the monobranched isoparaffins are monomethyl substituted isoparaffins, or monomethylalkanes, i.e. isoparaffins having one methyl sidechain or branch. In a preferred embodiment, the multiple branched isoparaffins are at least dimethyl substituted isoparaffins, preferably dimethyl, trimethyl, or higher substituted isoparaffins, or dimethyl, trimethyl, or higher substituted alkanes.

The combined yield of propene and ethene from the thermal cracking step is promoted by using a renewable isomeric paraffin composition, wherein the ratio of the wt-% amount of the monobranched isoparaffins to the wt-% amount of the multiple branched isoparaffins in the isomeric paraffin composition is at least 1.00. In other words, using as cracking feed an isomeric paraffin composition, wherein at least half of the isoparaffins (expressed in wt-% amounts) of the isomeric paraffin composition are monobranched promotes the formation of ethene and propene in the thermal cracking process.

It has been found that increasing the amount of monobranched isoparaffins while lowering the amount of multiple branched isoparaffins promotes the formation of ethene and propene in the thermal cracking process. Therefore, said ratio of the wt-% amount of the monobranched isoparaffins to the wt-% amount of the multiple branched isoparaffins is preferably at least 1.25. More preferably the ratio of the wt-% amount of the monobranched isoparaffins to the wt-% amount of the multiple branched isoparaffins in the isomeric paraffin composition is at least 1.50. Even more preferably, said ratio is at least 1.75 in the isomeric paraffin composition. Most preferably, the ratio of the wt-% amount of the monobranched isoparaffins to the wt-% amount of the multiple branched isoparaffins in the isomeric paraffin composition is at least 1.90. The higher the ratio of the wt-% amount of the monobranched isoparaffins to the wt-% amount of multiple branched isoparaffins in the isomeric paraffin composition is, the higher is the combined yield of propene and ethene. For example, in an embodiment, the ratio of the wt-% amount of the monobranched isoparaffins to the wt-% amount of multiple branched isoparaffins in the isomeric paraffin composition is at least 7, such as 7.5 or more. In an embodiment, the ratio of the wt-% amount of the monobranched isoparaffins to the wt-% amount of the multiple branched isoparaffins in the isomeric paraffin composition is selected from about 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9 and 4.0. In an embodiment, the ratio of the wt-% amount of the monobranched isoparaffins to the wt-% amount of the multiple branched isoparaffins in the isomeric paraffin composition is selected from the range from 2.0 to 4.0, preferably from 2.5 to 4.0, more preferably from 3.0 to 3.5. In an embodiment, the isoparaffins of the isomeric paraffin composition are predominantly monobranched isoparaffins.

As mentioned above, the combined yield of propene and ethene is enhanced by increasing the amount of monobranched isoparaffins while lowering the amount of multiple branched isoparaffins. Thus, low wt-% amounts of multiple branched isoparaffins are preferred. Preferably, the content of multiple branched isoparaffins of the isomeric paraffin composition is less than 40 wt-%, preferably less than 35 wt-%, more preferably less than 30 wt-%, and even more preferably less than 25 wt-%. The multiple branched isoparaffins content is preferably no more than 25 wt-%, further preferably no more than 20 wt-%, more preferably no more than 18 wt-%, even more preferably no more than 17 wt-%, and most preferably no more than 16.5 wt-%. In an embodiment, the isomeric paraffin composition comprises no more than 10 wt-% of multiple branched isoparaffins. In an embodiment, the multiple branched paraffin content of the isomeric paraffin composition is 6 wt-% or less. Multiple branched isoparaffins promotes formation of lighter (C1) and heavier (C5+) products during thermal cracking, instead of promoting the formation of ethene (C2) and propene (C3).

Preferably, the isomeric paraffin composition contains at least 5 wt-% of monobranched isoparaffins. More preferably, the isomeric paraffin composition comprises at least 30 wt-% of monobranched isoparaffins. In an embodiment, the isomeric paraffin composition contains at least 40 wt-% monobranched isoparaffins. In an embodiment, the monobranched isoparaffin content of the isomeric paraffin composition is about 45 wt-%.

It has been found, that both the wt-% amount of monobranched isoparaffins and the wt-% amount of multiple branched isoparaffins affect the combined yield of ethene and propene. In other words, decreasing the multiple branched isoparaffin content does not achieve an increase in the combined yield of propene and ethene unless the monobranched isoparaffin content is high enough. Correspondingly, increasing the amount of monobranched paraffins does not alone achieve an increase in the combined yield of propene and ethene unless the multiple branched isoparaffin content is low enough.

Preferably, the content (wt-%) of isoparaffins in the isomeric paraffin composition is at least 45 wt-%. A certain amount of isoparaffins ensures sufficient cold properties. More preferably, the isoparaffin content of the isomeric paraffin composition is at least 46 wt-%. In a further preferred embodiment, the isoparaffin content of the isomeric paraffin composition is at least 47 wt-%. In yet a preferred embodiment, the isoparaffin content is at least 48 wt-%.

In an embodiment, the isomeric paraffin composition contains less than 65 wt-% isoparaffins. In a preferred embodiment, the isomeric paraffin composition comprises less than 60 wt-% isoparaffins. More preferably, the isoparaffin content of the isomeric paraffin composition is less than 50 wt-%. In an embodiment, the isoparaffin content is no more than 49.5 wt-%. Preferably, the isoparaffin content is no more than 49 wt-%. In a further preferred embodiment, the isoparaffin content is no more than 48.5 wt-%. It has been found that providing an isomeric paraffin composition containing moderately isoparaffins, i.e. that is not highly or extensively isomerized, improves the combined ethene and propene yield.

The remainder of the paraffins in the isomeric paraffin composition are n-paraffins. In other words, the paraffins of the isomeric paraffin composition that are not isoparaffins are n-paraffins. In an embodiment, the n-paraffin content of the isomeric paraffin composition is selected from the range from 5 wt-% to 90 wt-%. Preferably, the n-paraffin content is at least 10 wt-%. Further preferably, the n-paraffin content of the isomeric paraffin composition is no more than 89 wt-%. Most preferably, the n-paraffin content is about 50 wt-%, for example about 48 wt-%, 49 wt-%, 50 wt-%, or 51 wt-%. Preferably, the n-paraffin content of the isomeric paraffin composition is from 40 wt-% to 60 wt-%. More preferably, the n-paraffin content is from 45 to 55 wt-%. Providing an isomeric paraffin composition containing moderately n-paraffins increases the combined ethene and propene yield in the thermal cracking step.

In an embodiment, the isomeric paraffin composition contains less than 50 wt-% isoparaffins, the wt-% amount of monobranched isoparaffins to the wt-% amount of multiple branched isoparaffins being at least 1.2. In a further embodiment, the isomeric paraffin composition contains less than 50 wt-% isoparaffins, the wt-% amount of monobranched isoparaffins to the wt-% amount of multiple branched isoparaffins being at least 1.9. Such isomeric paraffin compositions have been found to particularly increase the combined ethene and propene yield in the thermal cracking step.

In an embodiment, the isomeric paraffin composition contains at least 45 wt-% and less than 65 wt-% isoparaffins, the ratio of the wt-% amount of the monobranched isoparaffins to the wt-% amount of the multiple branched isoparaffins in the isomeric paraffin composition being at least 3.5, such as at least 4.0. In an embodiment, the isomeric paraffin composition contains at least 45 wt-% and less than 65 wt-% isoparaffins, the ratio of the wt-% amount of the monobranched isoparaffins to the wt-% amount of the multiple branched isoparaffins in the isomeric paraffin composition being in the range from 3.5 to 4.0. Isomeric paraffin compositions as in the embodiments described here before have good cold properties, and particularly promotes the formation and ethene and propene in the thermal cracking step due to the ratio of monobranched isoparaffins to multiple branched isoparaffins and the moderate isomerization degree.

Without being bound by any theory, it is believed that during the isomerization the substitution, particularly monomethyl substitution, is most likely in the second carbon atom in the linear carbon chain, and that the substitution of the second carbon promotes the formation of propene because the tertiary carbon bonds are most susceptible for cracking. Linear n-paraffins tend to crack to ethene molecules whereas high branching, i.e. multibranched isoparaffins, promotes the formation of propene but also isobutene and other heavier components. Mono branching has been observed to promote the propene yield while the formation of C4+ hydrocarbons stays low. It has also been found that a high degree of isomerization and a high number of multiple branched isoparaffins promote the formation of heavier (C5+) products. Hence, increasing the number of monomethyl substituted isoparaffins and reducing the number of multiple substituted isoparaffins is beneficial for the combined ethene and propene yield.

In the present invention, the total (wt-%) amount of paraffins in the isomeric paraffin composition is determined relative to all organic material which is fed to the cracker (relative to all organic material in the isomeric paraffin composition). The (wt-%) amounts of monobranched isoparaffins, multiple branched isoparaffins and n-paraffins are determined relative to the total paraffin content in the isomeric paraffin composition.

The (wt-%) amounts of monobranched isoparaffins, multiple branched isoparaffins, and n-paraffins may be determined using GC-FID analysis, as explained in the Examples, or by any other suitable method. In general, any isomeric paraffin composition as defined above can be used in the present invention. Nevertheless, two specific paraffin fractions (A and B) are to be mentioned, since they provide particularly desirable product distribution. Fractions A and B are also favourable in view of health, environment, and safety (HSE). What is defined above for the isomeric paraffin composition applies also for fractions A and B.

Fraction A comprises more than 50 wt-%, preferably 75 wt-% or more, more preferably 90 wt-% or more of C10-C20 hydrocarbons (based on the organic components). The content of even-numbered hydrocarbons in the C10-C20 range (i.e. C10, C12, C14, C16, C18, and C20) is preferably more than 50 wt-%. The fraction A contains no more than 1.0 wt-%, preferably 0.5 wt-% or less, more preferably 0.2 wt-% or less aromatics, and less than 2.0, preferably 1.0 wt-% or less, more preferably 0.5 wt-% or less of olefins, and no more than 5.0 wt-%, preferably 2.0 wt-% or less naphthenes. Fraction B comprises more than 50 wt-%, preferably 75 wt-% or more, more preferably 90 wt-% or more of C5-C10 hydrocarbons (based on the organic components). The fraction B contains no more than 1.0 wt-%, preferably 0.5 wt-% or less, more preferably 0.2 wt-% or less aromatics, and less than 2.0 wt-%, preferably 1.0 wt-% or less, more preferably 0.5 wt-% or less of olefins, and no more than 5.0 wt-%, preferably 2.0 wt-% or less naphthenes. A low amount of aromatics, olefins, and naphthenes in the thermal cracking feed improves the product distribution of the cracking process. In other words, the smaller the amount (wt-%) of aromatics, olefins, and naphthenes in the thermal cracking feed, the better the product distribution of the cracking process. “Better product distribution” refers in this context to a product distribution containing more high value products.

In any case, the isomeric paraffin composition preferably contains at most 1 wt-% oxygen based on all elements constituting the isomeric paraffin composition, as determined by elemental analysis. A low oxygen content of the isomeric paraffin composition (the organic material fed to thermal cracking) allows carrying out the cracking in a more controlled manner, thus resulting in a more favourable product distribution.

Carbon atoms of renewable origin comprise a higher number of ¹⁴C isotopes compared to carbon atoms of fossil origin. Therefore, it is possible to distinguish between a renewable (isomeric) paraffin composition and paraffin compositions derived from fossil sources by analysing the ratio of ¹²C and ¹⁴C isotopes. Thus, a particular ratio of said isotopes can be used as a “tag” to identify a renewable (isomeric) paraffin composition and differentiate it from non-renewable paraffin compositions. The isotope ratio does not change in the course of chemical reactions.

Renewable Feedstock

In the present invention, the renewable feedstock may be obtained or derived from any renewable source, such as plants or animals, including fungi, yeast, algae and bacteria. Said plants and microbial sources may be genemanipulated. Preferably, the renewable feedstock comprises, or is obtained or derived from, oil (in particular fatty oil), such as plant or vegetable oil, including wood based oil, animal oil, fish oil, algae oil, and/or microbial oil, fat, such as plant or vegetable fat, animal fat, and/or fish fat, recycled fats of food industry, and/or combinations thereof. The renewable feedstock may comprise, or be obtained from or derived from, any other feedstock that can be subjected to biomass gasification or biomass to liquid (BTL) methods.

The renewable feedstock may be subjected to an optional pre-treatment before preparation of a hydrocarbon raw material, or of a renewable isomeric paraffin composition. Such pre-treatment may comprise purification and/or chemical modification, such as saponification or transesterification. If the renewable raw material is a solid material (at ambient conditions), it is useful to chemically modify the material so as to derive a liquid renewable feedstock. In a preferred embodiment, the renewable feedstock is a liquid renewable feedstock (at ambient conditions).

Preferably, the renewable feedstock comprises at least one of vegetable oil, vegetable fat, animal oil, and animal fat. These materials are preferred, since they allow providing a renewable feedstock having a predictable composition which can be adjusted as needed by appropriate selection and/or blending of the natural oil(s) and/or fat(s).

Hydrocarbon Raw Material and Preparation Thereof

The isomeric paraffin composition of the present invention may be provided by isomerizing a hydrocarbon raw material obtained from the renewable feedstock.

Generally, the hydrocarbon raw material may be produced from the renewable feedstock using any known method. Specific examples of a method for producing the hydrocarbon raw material are provided in the European patent application EP 1741768 A1. Also other methods may be employed, particularly another BTL method may be chosen, for example biomass gasification followed by a Fischer-Tropsch method.

In a preferred embodiment, preparing a hydrocarbon raw material from a renewable feedstock comprises subjecting the renewable feedstock to a deoxygenation treatment. Most renewable feedstock comprises materials having a high oxygen content. In an embodiment, the renewable feedstock comprises fatty acids, or fatty acid derivatives, such as triglycerides, or a combination thereof.

In the present invention, the deoxygenating method is not particularly limited and any suitable method may be employed. Suitable methods are, for example, hydrotreating, such as hydrodeoxygenation (HDO), catalytic hydrodeoxygenation (catalytic HDO), catalytic cracking (CC), or a combination thereof. Other suitable methods include decarboxylation and decarbonylation reactions, either alone or in combination with hydrotreating.

In a preferred embodiment, the deoxygenation treatment, to which the renewable feedstock is subjected, is hydrotreatment. Preferably, the renewable feedstock is subjected to hydrodeoxygenation (HDO) which preferably uses a HDO catalyst. Catalytic HDO is the most common way of removing oxygen and has been extensively studied and optimized. However, the present invention is not limited thereto. As the HDO catalyst, a HDO catalyst comprising hydrogenation metal supported on a carrier may be used. Examples include a HDO catalyst comprising a hydrogenation metal selected from a group consisting of Pd, Pt, Ni, Co, Mo, Ru, Rh, W or a combination of these. Alumina or silica is suited as a carrier, among others. The hydrodeoxygenation step may, for example, be conducted at a temperature of 100-500° C. and at a pressure of 10-150 bar (absolute).

Preparing a hydrocarbon raw material from the renewable feedstock may comprise a step of hydrocracking hydrocarbons in the hydrocarbon raw material. Thus, the chain length of the hydrocarbon raw material may be adjusted and the product distribution of the produced mixture of biohydrocarbons can be indirectly controlled.

Isomerization Treatment

The renewable isomeric paraffin composition of the present invention may be provided by subjecting at least straight chain hydrocarbons in the hydrocarbon raw material to an isomerization treatment to prepare the isomeric paraffin composition. The hydrocarbon raw material and its preparation is described above.

The isomerization treatment causes branching of hydrocarbon chains, i.e. isomerization, of the hydrocarbon raw material. Branching of hydrocarbon chains improves cold properties, i.e. the isomeric composition formed by the isomerization treatment has better cold properties compared to the hydrocarbon raw material. Better cold properties refers to a lower temperature value of a pour point. The isomeric hydrocarbons, or isoparaffins, formed by the isomerization treatment may have one or more side chains, or branches. In a preferred embodiment, the formed isoparaffins have one or more C1-C9, preferably C1-C2, branches.

Subjecting the hydrocarbons of the hydrocarbon raw material to an isomerization treatment comprises controlling production of monobranched and multiple branched isoparaffins during the isomerization treatment. Usually, isomerization of the hydrocarbon raw material produces predominantly methyl branches.

The severity of isomerization conditions and choice of catalyst controls the amount of methyl branches formed and their distance from each other and thus influences the product distribution obtained after thermal cracking. The current inventors have found that the amounts and ratio of monobranched, preferably monomethyl substituted, isoparaffins and multiple branched isoparaffins influences the combined yield of ethene and propene in the thermal cracking step.

Providing the renewable isomeric paraffin composition preferably comprises subjecting at least a part of the straight chain alkanes, or paraffins, in the hydrocarbon raw material to an isomerization treatment, and controlling production of monobranched and multiple branched isoparaffins, to prepare the isomeric paraffin composition. The straight chain alkanes or a portion of the straight chain alkanes may be separated from the remainder of the hydrocarbon raw material, the separated straight chain alkanes then subjected to isomerization treatment and then optionally re-unified with the remainder of the hydrocarbon raw material. In an embodiment, a portion of the straight chain alkanes is separated from the remainder of the hydrocarbon raw material, the separated straight chain alkanes then subjected to isomerization treatment and then re-unified with the remainder of the hydrocarbon raw material. Alternatively, all of the hydrocarbon raw material may be subjected to isomerization treatment.

The isomerization treatment is not particularly limited. Preferably, the isomerization treatment is a catalytic isomerization treatment. It is preferred that only a part of the hydrocarbon raw material is subjected to an isomerization step. In a preferred embodiment, the part of the hydrocarbon raw material corresponding to a heavy fraction boiling at or above a temperature of 300° C. is subjected to an isomerization step, preferably combined with a catalytic cracking step. The high boiling point part, or heavy fraction, of the hydrocarbon raw material, after optional catalytic cracking, results mainly in a diesel range fraction after isomerization. Thermally cracking the diesel fraction leads to improved product distribution.

The isomerization step may be carried out in the presence of an isomerization catalyst, and optionally in the presence of hydrogen added to the isomerisation process. Suitable isomerisation catalysts contain a molecular sieve and/or a metal selected from Group VIII of the periodic table and optionally a carrier. Preferably, the isomerization catalyst contains SAPO-11, or SAPO-41, or ZSM-22, or ZSM-23, or ferrierite, and Pt, Pd, or Ni, and Al₂O₃, or SiO₂. Typical isomerization catalysts are, for example, Pt/SAPO-11/Al₂O₃, Pt/ZSM-22/Al₂O₃, Pt/ZSM-23/Al₂O₃, and Pt/SAPO-11/SiO₂. The catalysts may be used alone or in combination. The presence of added hydrogen is particularly preferable to reduce catalyst deactivation. In a preferred embodiment, the isomerization catalyst is a noble metal bifunctional catalyst, such as Pt-SAPO and/or Pt-ZSM-catalyst, which is used in combination with hydrogen. The isomerization step may, for example, be conducted at a temperature of 200-500° C., preferably 280-400° C., and at a pressure of 20-150 bar, preferably 30-100 bar (absolute). The isomerization step may comprise further intermediate steps such as a purification step and a fractionation step.

Incidentally, the isomerization treatment is a step which predominantly serves to isomerize the hydrocarbon raw material. That is, while most thermal or catalytic conversions (such as HDO) result in a minor degree of isomerization (usually less than 5 wt-%), the isomerization step which may be employed in the present invention is a step which leads to a significant increase in the isoparaffin content. The isomerization treatment is also the step predominantly controlling the amounts of monobranched and multiple branched isoparaffins in the prepared isomeric paraffin composition.

It is preferred that the ratio of the wt-% amount of the monobranched isoparaffins to the wt-% amount of the multiple branched isoparaffins after isomerization is at least 1.00, preferably at least 1.25, more preferably at least 1.50, even more preferably at least 1.75, and most preferably at least 1.90. In other word, it is preferred that at least half of the isoparaffins are monobranched isoparaffins. Even more preferably, the majority of the isoparaffins are monobranched isoparaffins. In an embodiment, the ratio of the wt-% amount of the monobranched isoparaffins to the wt-% amount of the multiple branched isoparaffins of the intermediate product after isomerization is selected from about 1.1, 1.2, 1.3, 1.4, 1.5, 1.6, 1.7, 1.8, 1.9, 2.0, 2.1, 2.2, 2.3, 2.4, 2.5, 2.6, 2.7, 2.8, 2.9, 3.0, 3.1, 3.2, 3.3, 3.4, 3.5, 3.6, 3.7, 3.8, 3.9 and 4.0. In an embodiment, the ratio of the wt-% amount of the monobranched isoparaffins to the wt-% amount of the multiple branched isoparaffins of the intermediate product after isomerization is selected from the range from 2.0 to 4.0, preferably from 2.5 to 4.0, more preferably from 3.0 to 3.5. In an embodiment, the formed isoparaffins are predominantly monobranched isoparaffins.

Further, it is preferred to particularly control the formation of multiple branched isoparaffins during the isomerization treatment. Preferably, the content of multiple branched isoparaffins of the intermediate product after isomerization is less than 40 wt-%, preferably less than 35 wt-%, more preferably less than 30 wt-%, and even more preferably less than 25 wt-%. The multiple branched isoparaffin content is preferably no more than 25 wt-%, further preferably no more than 20 wt-%, more preferably no more than 18 wt-%, even more preferably no more than 17 wt-%, and most preferably no more than 16.5 wt-%.

It is preferred that the isoparaffin content (wt-%) is increased by the isomerization treatment by at least 10 percentage points, more preferably at least 20 percentage points, and even more preferably at least 40 percentage points. More specifically, assuming that the isoparaffin content of the hydrocarbon raw material (organic material in the liquid component) is 1 wt-%, then the isoparaffin content of the intermediate product after isomerization is most preferably at least 45 wt-% (an increase of 44 percentage points). In an embodiment, the isoparaffin content of the intermediate product after isomerization is selected from about 45 wt-%, about 46 wt-%, about 47 wt-%, about 48 wt-%, and about 48 wt-%.

However, it is preferred that the isomerization degree is not increased superfluously. Preferably, the isoparaffin content of the intermediate product after isomerization is less than 95 wt-%, preferably less than 90 wt-%, more preferably less than 60 wt-%, even more preferably less than 50 wt-%. Preferably, the isoparaffin content is no more than 49.5 wt-%, more preferably no more than 49 wt-%, and even more preferably no more than 48.5 wt-%. The isoparaffin content can be limited by the isomerization reaction conditions such as temperature, pressure, residence time and hydrogen content. Moderate isomerization of the hydrocarbon raw material results in enough isoparaffins to achieve appropriate cold properties, a high number of monobranched isoparaffins and relatively low content of other branched paraffins. These features are favorable with respect to high cracker yields of ethene and propene, and to improved cold properties.

An isomeric paraffin composition obtained by an isomerization treatment as described above may be fed directly to the thermal cracking procedure. In an embodiment, the isomeric paraffin composition obtained by an isomerization treatment as described above is re-unified directly with the remainder of the hydrocarbon raw material and then fed directly to the thermal cracking procedure. That is, no purification is necessary after the isomerization step, so that the efficiency of the process can be further improved.

The hydrotreatment step and the isomerization step may be conducted in the same reactor. Alternatively, hydrotreatment step and the isomerization step may be conducted in separate reactors. Water and light gases, such as carbon monoxide, carbon dioxide, hydrogen, methane, ethane, and propane, may be separated from the hydrotreated or hydrocracked composition and/or from the isomeric paraffin composition with any conventional means, such as distillation, before thermal cracking. After or along with removal of water and light gases, the composition may be fractionated to one or more fractions, each of which may be provided as the isomeric paraffin composition in the thermal cracking step. The fractionation may be conducted by any conventional means, such as distillation. Further, the isomeric paraffin composition may optionally be purified. The purification and/or fractionation allows better control of the properties of the isomeric paraffin composition, and thus the properties of the hydrocarbon mixture produced in the thermal cracking step.

In an preferred embodiment, a renewable feedstock comprising at least one of vegetable oil, vegetable fat, animal oil, and animal fat is subjected to hydrotreatment and isomerization, wherein production of monobranched and multiple branched isoparaffins is controlled during the isomerization treatment, to prepare an isomeric paraffin composition. Preferably, the isomeric paraffin composition comprises at least one of a diesel range fraction (boiling point: 180-360° C., as measured according to EN-ISO-3405 (2011)) and a naphtha range fraction (boiling point: 30-180° C., as measured according to EN-ISO-3405 (2011)). In an embodiment, the isomeric paraffin composition comprises the diesel range fraction. In an alternative embodiment, the isomeric paraffin composition comprises the naphtha range fraction. The isomeric paraffin composition comprising the diesel range fraction and/or the naphtha range fraction is then subjected to thermal cracking, preferably steam cracking. That is, in an embodiment only the diesel range fraction is subjected to thermal cracking, wherein an alternative embodiment comprises subjecting only the naphtha range fraction to thermal cracking. In yet an embodiment, a mixture of the diesel range fraction and the naphtha range fraction is subjected to thermal cracking. Most preferably, the diesel range fraction is subjected to thermal cracking.

Using these fractions, in particular such fractions derived from renewable oil and/or fat, allows good control of the composition of the isomeric paraffin composition, and thus of the mixture of biohydrocarbons produced by the method of the first aspect of the invention. Thermally cracking said fraction or fractions gives a desirable product distribution in the thermal cracking step.

Thermal Cracking of the Isomeric Paraffin Composition

Preferably, the thermal cracking of step (b) of the method according to the first aspect of the invention is steam cracking. Steam cracking facilities are widely used in petrochemical industry and the processing conditions are well known, thus requiring only few modifications of established processes. A conventional naphtha (steam) cracker, i.e. a cracker commonly used to thermally crack fossil naphtha, is preferably used to conduct the thermal cracking step. Thermal cracking is preferably carried out without catalyst. However, additives, such as dimethyl disulphide (DMDS), may be used in the cracking step to reduce coke formation.

A good combined ethene and propene yield, i.e. a combined ethene and propene yield of more than 45 wt-%, can be obtained performing the thermal cracking step at a COT selected from a wide temperature range. The COT is usually the highest temperature in the cracker. In the present invention, the thermally cracking the renewable isomeric paraffin composition is preferably conducted at a coil outlet temperature (COT) selected from the range from 780° C. to 890° C. In a preferred embodiment, the thermal cracking is conducted at a COT selected from the range from 800° C. to 860° C.

The combined ethene and propene yield is particularly enhanced at COTs selected from the range from 800° C. to 840° C. Therefore, in yet a preferred embodiment, the COT is selected from the range from 800° C. to 840° C. The highest combined ethene and propene yield is obtained when the thermal cracking is conducted at a COT of about about 820° C. Therefore, the COT is even more preferably selected from the range from 800° C. to 820° C. Most preferably, the thermal cracking is conducted at a COT of about 820° C. The COT may, for example, be about 810° C., 815° C., 820° C., 825° C., or 830° C. Temperatures selected from the lower part of the above temperature ranges, particularly temperatures below 800° C., may increase the wt-% amount of unreacted educts. However, recycling unconverted reactants to the thermal cracking allows a very high overall yield of the process.

The thermal cracking preferably comprises steam cracking. Steam cracking is preferably performed at a flow rate ratio between water and the isomeric paraffin composition (H₂O flow rate [kg/h]/iso-HC flow rate [kg/h]) of 0.05 to 1.20. In a preferred embodiment, the flow rate ratio between water and the isomeric paraffin composition is selected from 0.10 to 1.00. In yet a preferred embodiment, the flow rate ratio between water and the isomeric paraffin composition is selected from 0.20 to 0.80. Even more preferably, the flow rate ratio between water and the isomeric paraffin composition is selected from 0.25 to 0.70. Yet more preferably, the flow rate ratio between water and the isomeric paraffin composition is selected from 0.25 to 0.60. A flow rate ratio selected from the range of 0.3 to 0.50 is favourable, since it allows production of the desired products with high yield. Hence, yet more preferably, the flow rate ratio between water and the isomeric paraffin composition is selected from 0.30 to 0.50. A particularly good combined ethene and propylene yield is obtained, when the flow rate ratio between water and the isomeric paraffin composition is about 0.5. Therefore, about 0.5 is the most preferred flow rate ratio between water and the isomeric paraffin composition.

In general, the coil outlet pressure in the thermal cracking step is in the range of 0.9 to 3.0 bar (absolute), preferably at least 1.0 bar, more preferable at least 1.1 bar or 1.2 bar, and preferably at most 2.5 bar, more preferably at most 2.2 bar or 2.0 bar.

In an embodiment, the steam cracking is performed at a flow rate ratio between water and the isomeric paraffin composition (H₂O flow rate [kg/h]/iso-HC flow rate [kg/h]) of 0.30 to 0.50, and at a COT selected from the range from 800 to 820° C. In a further embodiment, the steam cracking is performed at a flow rate ratio between water and the isomeric paraffin composition (H₂O flow rate [kg/h]/iso-HC flow rate [kg/h]) of 0.30 to 0.50, and at a COT selected from the range from 800 to 840° C. A particularly good combined ethene and propylene yield is obtained using the above process parameters.

In an embodiment, the ratio of the wt-% amount of the monobranched isoparaffins to the wt-% amount of the multiple branched isoparaffins of the provided isomeric paraffin composition is at least 1.2, and the steam cracking is conducted at a COT selected from a range from 780 to 840° C., and at a flow rate ratio between water and the isomeric paraffin composition (H₂O flow rate [kg/h]/iso-HC flow rate [kg/h]) of 0.35 to 0.50. A particularly good combined ethene and propylene yield is obtained using the above isomeric paraffin composition and process parameters.

In an embodiment, the method of the first aspect comprises providing an isomeric paraffin composition containing at least 45 wt-% and less than 65 wt-% isoparaffins, the ratio of the wt-% amount of the monobranched isoparaffins to the wt-% amount of the multiple branched isoparaffins in the isomeric paraffin composition being at least 3.5, such as at least 4.0 0, and thermally cracking said renewable isomeric paraffin composition to produce a mixture of biohydrocarbons containing propene and ethene. Further, in an embodiment, the method of the first aspect comprises providing a renewable isomeric paraffin composition containing at least 45 wt-% and at most 65 wt-% isoparaffins, the ratio of the wt-% amount of the monobranched isoparaffins to the wt-% amount of the multiple branched isoparaffins being in the range from 3.5 to 4.0 and thermally cracking said renewable isomeric paraffin composition to produce a mixture of biohydrocarbons containing propene and ethene. Methods as in the embodiments described here before particularly promotes the formation of ethene and propene in the thermal cracking step due to the ratio of monobranched isoparaffins to multiple branched isoparaffins in the isomeric paraffin composition and the moderate isomerization degree of the isomeric paraffin composition.

In an embodiment, a combined ethene and propene yield of at least 50 wt-% can be obtained by providing an isomeric paraffin composition, wherein the ratio of the wt-% amount of the monobranched isoparaffins to the wt-% amount of the multiple branched isoparaffins is at least 1.2. In a further embodiment, a combined ethene and propene yield of at least 50 wt-% can be obtained by providing an isomeric paraffin composition, wherein the ratio of the wt-% amount of the monobranched isoparaffins to the wt-% amount of the multiple branched isoparaffins is at least 1, and performing the thermal cracking step at a COT selected from a range from 780 to 840° C., and at a flow rate ratio between water and the isomeric paraffin composition (H₂O flow rate [kg/h]/iso-HC flow rate [kg/h]) of 0.35 to 0.50.

In an embodiment, a combined ethene and propene yield of at least 57 wt-% can be obtained by providing an isomeric paraffin composition, wherein the ratio of the wt-% amount of the monobranched isoparaffins to the wt-% amount of the multiple branched isoparaffins is at least 1.9, and performing the thermal cracking step at a COT selected from a range from 800 to 820° C., and at a flow rate ratio between water and the isomeric paraffin composition (H₂O flow rate [kg/h]/iso-HC flow rate [kg/h]) of 0.50.

Cracking Products

The term “cracking products” may refer to products obtained directly after a thermal cracking step, or to their derivatives, i.e. “cracking products” as used herein refers to the hydrocarbon species in the mixture of biohydrocarbons, and their derivatives. “Obtained directly after a thermal cracking step” may be interpreted as including optional separation and/or purification steps. As used herein, the term “cracking product” may also refer to the mixture of biohydrocarbons obtained directly after the thermal cracking step as a whole.

The cracking products described herein are examples of cracking products obtainable with the present invention. The cracking products of a certain embodiment may include one or more of the following cracking products.

The present invention allows obtaining a mixture of biohydrocarbons having a good combined yield of ethene and propylene by thermally cracking the isomeric paraffin composition. Both propene and ethene are well suited for the production of petrochemical raw material, in particular as monomers or monomer precursors in polymer industry. The present invention provides a favourable product distribution containing a high combined amount of ethene and propene obtained or derived from an environmentally friendly renewable source.

Preferably, the combined yield of ethene and propylene is more than 45 wt-%, i.e. the mixture of biohydrocarbons comprises more than 45 wt-% ethene and propene. More preferably, the produced mixture of biohydrocarbons comprises at least 50 wt-% propene and ethene combined. Further preferably, the mixture of biohydrocarbons contains at least 55 wt-% of ethene and propene combined. Most preferably, the mixture of biohydrocarbons comprises at least 57 wt-% propene and ethene combined.

Further, the present invention provides a mixture of biohydrocarbons obtainable by the method according to the first aspect. The mixture of hydrocarbons corresponds to the mixture which is directly obtained after thermal cracking without further purification.

Carbon atoms of renewable origin comprise a higher number of ¹⁴C isotopes compared to carbon atoms of fossil origin. Therefore, it is possible to distinguish hydrocarbons of renewable origin (biohydrocarbons) from non-renewable hydrocarbons by analysing the ratio of ¹²C and ¹⁴C isotopes. By analysing the ratio of ¹²C and ¹⁴C isotopes it can also be determined whether or not a renewable feedstock has been used in thermal cracking. Thus, a particular ratio of said isotopes can be used as a “tag” to identify a mixture of biohydrocarbons and differentiate it from non-renewable mixtures of hydrocarbons. Because the isotope ratio does not change in the course of chemical reactions, the isotope ratio and, consequently, renewable origin of the biohydrocarbons, can be detected also in chemicals and/or polymers synthesised from the biohydrocarbons mixture obtainable by the present method. Thus, the isotope ratio reliably characterises biohydrocarbons according to the invention, the biohydrocarbons achieving certain technical effects, such as more favourable HSE properties, technically meet consumer needs, or a certain technical standard.

The present invention further provides use of the mixture of biohydrocarbons for producing chemicals and/or polymers. Particularly, use of the ethene and propene obtained with the method of the first aspect of the invention for producing chemicals and/or polymers, such as polyethene and polypropene, is provided. Use of the mixture of biohydrocarbons for producing chemicals and/or polymers may comprise a separation step to separate at least a hydrocarbon compound from the mixture of biohydrocarbons.

In a preferred embodiment, the cracking products include one or more of hydrogen, methane, ethane, ethene, propane, propene, propadiene, butane and butylenes, such as butene, iso-butene, and butadiene, C5+ hydrocarbons, such as aromatics, benzene, toluene, xylenes, and C5-C18 paraffins and olefins, and their derivatives.

Such derivatives are, for example, methane derivatives, ethene derivatives, propene derivatives, benzene derivatives, toluene derivatives, and xylene derivatives, and their derivatives.

Methane derivatives include, for example, ammonia, methanol, phosgene, hydrogen, oxochemicals and their derivatives, such as methanol derivatives. Methanol derivatives include, for example, methyl methacrylate, polymethyl methacrylate, formaldehyde, phenolic resins, polyurethanes, methyl-tert-butyl ether, and their derivatives.

Ethene derivatives include, for example, ethylene oxide, ethylene dichloride, acetaldehyde, ethylbenzene, alpha-olefins, and polyethylene, and their derivatives, such as ethylene oxide derivatives, ethylbenzene derivatives, and acetaldehyde derivatives. Ethylene oxide derivatives include, for example, ethylene glycols, ethylene glycol ethers, ethylene glycol ethers acetates, polyesters, ethanol amines, ethyl carbonates and their derivatives. Ethylbenzene derivatives include, for example, styrene, acrylonitrile butadiene styrene, styrene-acrylonitrile resin, polystyrene, unsaturated polyesters, and styrene-butadiene rubber, and their derivatives. Acetaldehyde derivatives include, for example, acetic acid, vinyl acetate monomer, polyvinyl acetate polymers, and their derivatives. Ethyl alcohol derivatives include, for example, ethyl amines, ethyl acetate, ethyl acrylate, acrylate elastomers, synthetic rubber, and their derivatives. Further, ethene derivatives include polymers, such as polyvinyl chloride, polyvinyl alcohol, polyester such as polyethylene terephthalate, polyvinyl chloride, polystyrene, and their derivatives.

Propene derivatives include, for example, isopropanol, acrylonitrile, polypropylene, propylene oxide, acrylic acid, allyl chloride, oxoalcohols, cumens, acetone, acrolein, hydroquinone, isopropylphenols, 4-hethylpentene-1, alkylates, butyraldehyde, ethylene-propylene elastomers, and their derivatives. Propylene oxide derivatives include, for example, propylene carbonates, allyl alcohols, isopropanolamines, propylene glycols, glycol ethers, polyether polyols, polyoxypropyleneamines, 1,4-butanediol, and their derivatives. Allyl chloride derivatives include, for example, epichlorohydrin and epoxy resins. Isopropanol derivatives include, for example, acetone, isopropyl acetate, isophorone, methyl methacrylate, polymethyl methacrylate, and their derivatives. Butyraldehyde derivatives include, for example, acrylic acid, acrylic acid esters, isobutanol, isobutylacetate, n-butanol, n-butylacetate, ethylhexanol, and their derivatives. Acrylic acid derivatives include, for example, acrylate esters, polyacrylates and water absorbing polymers, such as super absorbents, and their derivatives.

Butylene derivatives include, for example, alkylates, methyl tert-butyl ether, ethyl tert-butyl ether, polyethylene copolymer, polybutenes, valeraldehyde, 1,2-butylene oxide, propylene, octenes, sec-butyl alcohol, butylene rubber, methyl methacrylate, isobutylenes, polyisobutylenes, substituted phenols, such as p-tert-butylphenol, di-tert-butyl-p-cresol and 2,6-di-tert-butylphenol, polyols, and their derivatives. Other butadiene derivatives may be styrene butylene rubber, polybutadiene, nitrile, polychloroprene, adiponitrile, acrylonitrile butadiene styrene, styrene-butadiene copolymer latexes, styrene block copolymers, styrene-butadiene rubber.

Benzene derivatives include, for example, ethyl benzene, styrene, cumene, phenol, cyclohexane, nitrobenzene, alkylbenzene, maleic anhydride, chlorobenzene, benzene sulphonic acid, biphenyl, hydroquinone, resorcinol, polystyrene, styrene-acrylonitrile resin, styrene-butadiene rubber, acrylonitrile-butadiene-styrene resin, styrene block copolymers, bisphenol A, polycarbonate, methyl diphenyl diisocyanate and their derivatives. Cyclohexane derivatives include, for example, adipic acid, caprolactam and their derivatives. Nitrobenzene derivatives include, for example, aniline, methylene diphenyl diisocyanate, polyisocyanates and polyurethanes. Alkylbenzene derivatives include, for example, linear alkybenzene. Chlorobenzene derivatives include, for example, polysulfone, polyphenylene sulfide, and nitrobenzene. Phenol derivatives include, for example, bisphenol A, phenol form aldehyde resins, cyclohexanone-cyclohexenol mixture (KA-oil), caprolactam, polyamides, alkylphenols, such as p-nonoylphenol and p-dedocylphenol, ortho-xylenol, aryl phosphates, o-cresol, and cyclohexanol.

Toluene derivatives include, for example, benzene, xylenes, toluene diisocyanate, benzoic acid, and their derivatives.

Xylene derivatives include, for example, aromatic diacids and anhydrates, such as terephthalic acid, isophthalic acid, and phthalic anhydrate, and phthalic acid, and their derivatives. Derivatives of terephthalic acid include, for example, terephthalic acid esters, such as dimethyl terephthalate, and polyesters, such as polyethylene terephthalate, polytrimethylene terephthalate, polybutylene terephthalate and polyester polyols. Phthalic acid derivatives include, for example, unsaturated polyesters, and PVC plasticizers. Isophthalic acid derivatives include, for example, unsaturated polyesters, polyethylene terephthalate co-polymers, and polyester polyols.

As already mentioned previously, the biohydrocarbons obtained with the method according to the first aspect of the present invention are particularly suitable as raw materials for conventional petrochemistry, and in particular polymer industry. Specifically, the mixture of biohydrocarbons obtained from the present invention show a product distribution which is similar to, and even favourable over, the product distribution obtained from thermal (steam) cracking of conventional (fossil) raw material. Thus, these biohydrocarbons can be added to the known value-added chain while no significant modifications of production processes are required. In effect, it is thus possible to produce for example polymers derived exclusively from renewable material, or feedstock.

The cracking products of the current invention may be used in a wide variety of applications. Such applications are, for example, consumer electronics, composites, automotive, packaging, medical equipment, agrochemicals, coolants, footwear, paper, coatings, adhesives, inks, pharmaceuticals, electric and electronic appliances, sport equipment, disposables, paints, textiles, super absorbents, building and construction, fuels, detergents, furniture, sportwear, solvents, plasticizers and surfactants.

### EXAMPLES

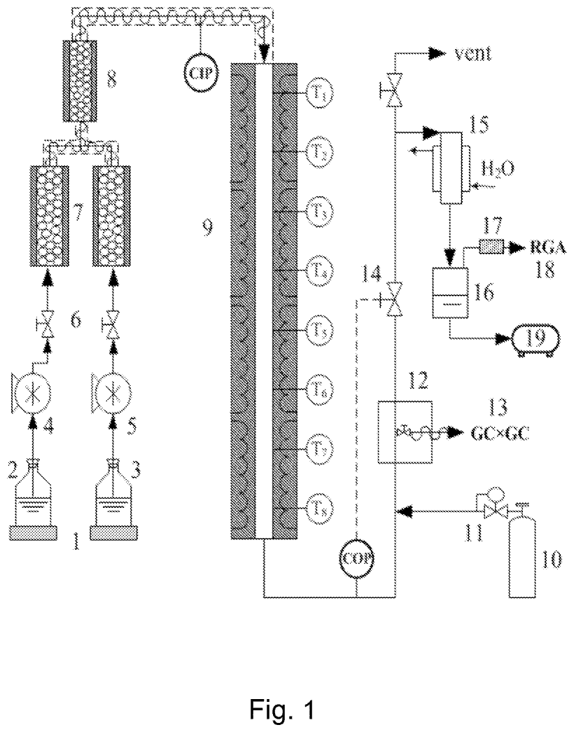

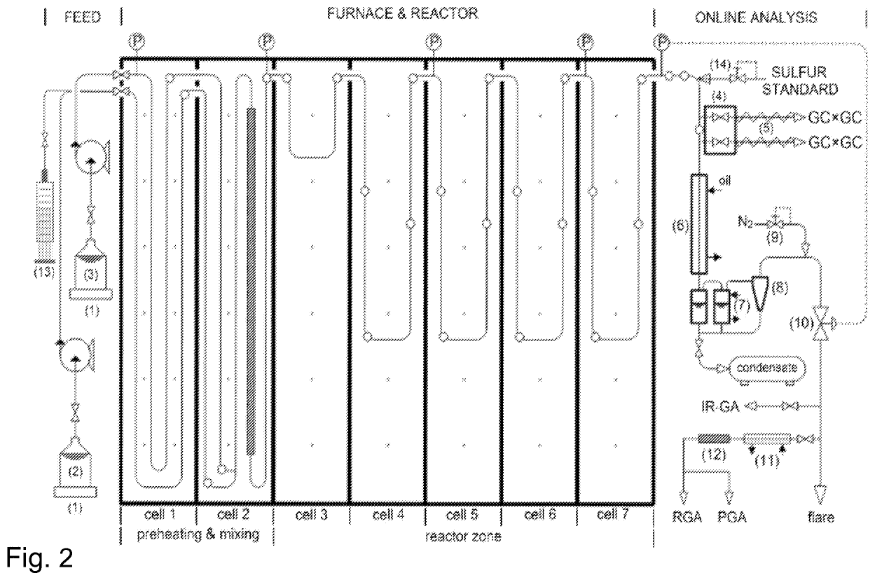

The examples illustrating some embodiments of the current invention were carried out using a laboratory scale equipment shown in FIG. 1, or a pilot scale equipment shown in FIG. 2.

In the laboratory scale equipment of FIG. 1, hydrocarbons and water are provided in reservoir 2 and 3, respectively. Mass flow is determined using an electronic balance 1.

Water and hydrocarbons are pumped into evaporators 7 via valves 6 using a water pump 5 and a peristaltic pump 4, respectively. Evaporated materials are mixed in mixer 8 and fed to the reactor 9 having sensors to determine temperatures T1 to T8. Coil inlet pressure (CIP) and coil outlet pressure (COP) are determined using sensors (CIP, COP) at appropriate positions. Reaction products are input into a GC×GC-FID/TOE-MS 13 via a heated sampling oven after having been admixed with an internal standard 10, the addition amount of which is controlled using a coriolis mass flow controller 11. Internal pressure of the reaction system is adjusted using the outlet pressure restriction valve 14. Further, water cooled heat exchanger 15, gas/liquid separator 16, dehydrator 17, refinery gas analyzer 18, and condensate drum 19 are provided to further analyze and recover the products.

Similarly, in the pilot scale equipment, or pilot plant steam cracker, of FIG. 2, hydrocarbons and water are provided in liquid hydrocarbon feed reservoir 2 and water (diluent) reservoir 3, respectively. Mass flow is determined using electronic balances 1. The sampling setup of the pilot scale equipment of FIG. 2 comprises a heated sampling oven 4, and heated transfer lines 5. Further, the pilot plant steam cracker of FIG. 2 comprises an oil cooled heat exchanger 6, a water cooled knock-out vessel 7, a cyclone 8, internal standard N₂ 9 and sulfur containing internal standard 3-chlorothiophene 14, a pressure regulating valve 10, a dehydrator 12, and an ISCO 500D syringe pump 13 to recover and further analyze the products.

Further, the pilot scale equipment of FIG. 2 comprises a furnace divided into seven separate cells, cell 1 to cell 7 in FIG. 2. The cells can be fired independently to set any type of temperature profile. Twenty thermocouples and eight manometers are located along the reactor coil to measure the temperature and pressure of the reacting gas. The most important process gas temperature and pressure measurement are in FIG. 2 indicated O and P, respectively. The pilot scale equipment of FIG. 2 comprises a thermal cracking tube. The reaction section of the tube is about 12 m long extending from cell 3 to cell 7, made of Incoloy™ 800HT, and has an internal diameter of 9 mm. The dimensions of the reaction section of the tube are chosen to achieve turbulent flow conditions in the coil with reasonable feed flow rates (Re>104).

Measurement of Isomerization Degree

N- and i-paraffin contents in the renewable isomeric paraffin composition were analyzed by gas chromatography (GC). The samples were analyzed as such, without any pretreatment. The method is suitable for hydrocarbons C2-C36. N-alkanes and groups of isoalkanes (C1-, C2-, C3-substituted and >C3-substituted) are identified using mass spectrometry and a mixture of known n-alkanes in the range of C2-C36. The chromatogram is integrated and compounds or compound groups are quantified by normalization using relative response factor of 1.0 to all hydrocarbons. The limit of quantitation for individual compounds was 0.01 wt-%. Settings of the determination of n- and i-paraffins are shown in Table 1.

TABLE 1
Settings of GC determination of n- and i-paraffins

| | GC |
|---|---|
| Injection | split/splitless-injector |
| | Split 80:1 (injection volume 0.2 μL) |
| Column | DB ™-5 |
| | (length 30 m, i.d. 0.25 m, phase thickness 0.25 μm) |
| Carrrie gas | He |
| Detector | FID (flame ionized detector) |
| GC program | 30° C. (2 min) - 5° C./min - 300° C. |
| | (30 min), constant flow 1, 1 mL/min) |

### Effluent Analysis

### Laboratory Scale Examples

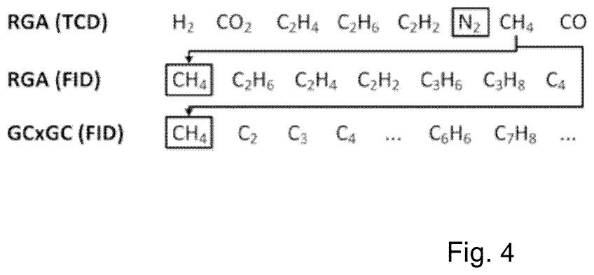

Effluent analysis of the cracking product in the laboratory scale examples, i.e. the examples carried out with the laboratory scale equipment of FIG. 1, was performed using the procedure described by Pyl et. al. (Pyl, S. P.; Schietekat, C. M.; Van Geem, K. M.; Reyniers, M.-F.; Vercammen, J.; Beens, J.; Marin, G. B., Rapeseed oil methyl ester pyrolysis: On-line product analysis using comprehensive two-dimensional gas chromatography. J. Chromatogr. A 2011, 1218, (21), 3217-3223). The quantification of the reactor effluent was done using an external standard (N₂) which was added to the reactor effluent in the sampling oven. In order to combine the data of the various instruments, having both thermal conductivity detector (TCD) and flame ionization detector (FID) detectors, multiple reference components were used. This is schematically presented in FIG. 4, and described more in detail here below.

The fraction of the reactor effluent containing the permanent gasses and the C4-hydrocarbons was injected on the refinery gas analyzer (RGA). Settings of the RGA are shown in Table 2. N₂, H₂, CO, CO₂, CH₂, ethane, ethene and acetylene were detected with a TCD. The mass flow rate of these species, dm/dt, was determined based on the known mass flow rate of the external standard N₂ using the following equation, where Aᵢ represents the surface area obtained by the detector. The response factor for each C4-species, f, was determined using a calibration mixture provided by Air Liquide, Belgium.

$${\dot{m}}_{l} = \frac{{f}_{i} {A}_{i}}{{f}_{{N}_{2}} {A}_{{N}_{2}}} {\dot{m}}_{{N}_{2}}$$

The FID detector on the RGA analyzes C1 to C4 hydrocarbons. Methane, detected on the TCD detector, acted as a secondary internal standard in order to quantify the other detected molecules using the following equation:

$${\dot{m}}_{l} = \frac{{f}_{i} {A}_{i}}{{f}_{{N}_{2}} {A}_{{CH}_{4}}} {\dot{m}}_{{CH}_{4}}$$

The comprehensive two-dimensional GC, known as GC×GC-FID, allows quantification of the entire effluent stream, aside from N₂, H₂, CO, CO₂, and H₂O. Methane was used as secondary internal standard. Settings of the GC×GC are shown in Table 3.

TABLE 2
(refinery gas analyzer settings, laboratory scale examples):

| | | RGA | | |
|---|---|---|---|---|
| | | channel 1 | channel 2 | channel 3 |
| Detector | | FID, 200° C. | TCD, 160° C. | TCD, 160° C. |
| Injection (gas) | | 50 μl, 80° C. | 250 μl, 80° C. | 250 μl, 80° C. |
| Carrier gas | | He | He | N₂ |
| Column | Pre | Rtx ™-1^{a} | Hayesep ™ Q | Hayesep ™ T |
| | Analytical | Rt ™-A1 BOND^{b} | Hayesep ™ N | Carbosphere ™ |
| | | | Molsieve ™ 5A | |
| Oven temperature | | 50 → 120° C. | 80° C. | 80° C. |
| | | (5° C./min) | | |

^{a}dimethyl polysiloxane (Restek),
^{b}divinylbenzene ethylene glycol/dimethylacrylate (Restek)

TABLE 3
(GC × GC settings, laboratory scale examples):

| | | GC × GC |
|---|---|---|
| Detectors | | FID, 300° C. |
| | | TOF-MS, 35-400 amu |
| Injection | Off-line | 0.2 μl, split flow 150 ml/min, 300° C. |
| | on-line | 250 μl (gas), split flow 20 ml/min, 300° C. |
| Carrier gas | | He |
| Column | First | Rtx ™-1 PONA^{a} |
| | Second | BPX ™-50^{b} |
| Oven temperature | Off-line | 40° C. → 250° C.(3° C./min) |
| | On-line | −40° C. (4 min hold) → 40° C. |
| | | (5° C./min) → 300° C. (4° C./min |
| Modulation period | | 5 s |

^{a}dimethyl polysiloxane (Restek),
^{b}50% phenyl polysilphenylene-siloxane (SGE)

Pilot Scale Examples

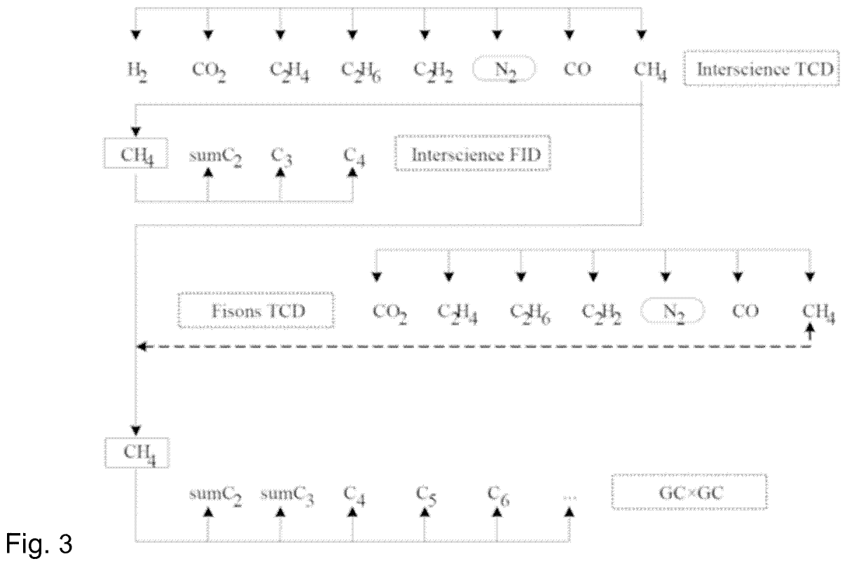

Pilot scale steam cracking trials and the effluent analysis of the cracking product in the pilot scale examples, i.e. the examples carried out with the pilot scale equipment of FIG. 2 were carried out as described in Dhuyvetter et al. (Ind. Eng. Chem. Res., 2001. 40(20): p. 4353-4362) and Van Geem et al. (Journal of Chromatography A, 2010. 1217(43): p. 6623-6633). The effluent in pilot plant, i.e. pilot scale equipment of FIG. 2, was sampled during pilot plant operations on-line and at several positions downstream of the reactor. Effluent analysis was performed using gas chromatography. GCs and reference components used in effluent analysis in the pilot scale examples are schematically presented in FIG. 3.

The C2-analysis of the quenched effluent gases was performed simultaneously on two gas chromatography (GC) devices. Two devices for the same analysis was used to check the data consistency, however, hydrogen was detected on one GC. The first system was an Interscience Trace™ GC Ultra. Hydrogen, carbon dioxide, carbon monoxide, nitrogen, methane, ethane, ethylene, and acetylene were all detected by a thermal conductivity detector (TCD), indicated as Interscience TDC in FIG. 3. The second system was an Interscience Fisons GC 8340 with a TCD, which detects the same components except for hydrogen, namely carbon dioxide, carbon monoxide, nitrogen, methane, ethane, ethylene, and acetylene. In FIG. 3, Interscience Fisons GC 8340 with a TCD is indicated as Fisons TDC. The C1 to C4 components were also analyzed with the Interscience Trace™ GC Ultra using a flame ionization detector (FID), indicated as Interscience FID in FIG. 3. Comprehensive two-dimensional GC, known as GC×GC-FID/TOF-MS and referred to as GC×GC in FIG. 3, was used to detect the C5+ components.

The identification of the peaks in the mass spectra GC×GC was performed using the molecular library implemented in XCalibur™ software. Interscience GC×GC was used for the analysis of all C5+ hydrocarbons. Peak identification and integration was performed using the integration packages ChromCard and GCImage. The effluent flow calculations were done by using nitrogen as internal standard. Methane was detected on both the Interscience Trace™ GC and GC×GC-FID, and used as a reference component to calculate the flows of the other C4− and C5+ components.

The settings of the RGA, used for quantification of the C4− components, employed during effluent analyses are listed in Table 4.

TABLE 4
(refinery gas analyzer settings, pilot scale experiments)

| | | RGA | | |
|---|---|---|---|---|
| | | channel 1 | channel 2 | channel 3 |
| Detector | | TCD, 160° C. | TCD, 160° C. | FID, 200° C. |
| Injection | | gas, 80° C. | gas, 80° C. | gas, 80° C. |
| Carrier gas | | N₂ | He | He |
| Column | Pre | Hayesep ™ T | Hayesep ™ Q | Rtx ™-1 |
| | | (1 ml × 1/8″ I.D.) | (0.25 ml × 1/8″ I.D.) | (15 ml × 0.53 mm I.D. × 3 μm df) |
| | Analytica | Carbosphere ™ | Molsieve ™ 5A | RT ™-Alumina BOND |
| | | (2 ml × 1/8″ I.D.) | (1 ml × 1/8″ I.D.) | (25 ml × 0.53 mm I.D. × 15 μm df) |
| Oven temperature | | 80° C. | 80° C. | 50 → 120° C. (5° C./min) |

Table 5 lists the GC×GC settings that were used for the analysis of the effluent during the pilot scale cracking examples. Methane was used as a secondary internal standard. The C5+ analyses were performed with GC×GC-FID.

TABLE 5
(GC × GC settings, RC1)

| Properties column 1 | | |
|---|---|---|
| type | PONA | |
| length | 50 | m |
| diameter | 250 | μm |
| stationary phase | dimethylpolysil oxane | |
| diameter stationary phase | 0.5 | μm |
| capacity factor | 8 | |
| Properties column 2 | | |
| type | BPX ™ 50 | |
| length | 2 | m |
| diameter | 150 | μm |
| diameter stationary | 0.15 | μm |
| phase | | |
| capacity factor | 6 | |
| Temperature program | | |
| Tᵢₙᵢₜᵢₐₗ = −40° C. | hold time 4 min | |
| rate = 5° C./min | | |
| T = 40° C. | hold time 0 min | |
| rate = 3° C./min | | |
| T_{final} = 300° C. | hold time 0 min | |
| Modulation | | |
| modulation time | 5 | seconds |
| delay time | 15 | minutes |
| Right inlet | | |
| temperature | 300° C. | |
| split ratio | 40-100 | |
| split flow | 80-200 | ml/min |
| Right carrier | | |
| flow | 2.1 | ml/min |
| Right detector - FID | | |
| Range | 10 | |
| flow air | 350 | ml/min |
| flow H2 | 35 | ml/min |

Renewable Isomeric Paraffin Compositions

Renewable Isomeric Paraffin Composition RC1

A mixture (isomeric paraffin composition) comprising about 6 wt-% monomethyl substituted isoparaffins, about 5 wt-% multibranched isoparaffins, and about 89 wt-% n-paraffins was provided. The composition of the mixture was analyzed by GC analysis and the results are shown in Table 6. The composition corresponds to a hydrocarbon composition (diesel fraction) derived from a renewable feedstock which is subjected to hydrotreating and isomerization. The ratio of the wt-% amount of monobranched isoparaffins to the wt-% amount of multiple branched isoparaffins is 1.2 in composition RC1.

Renewable Isomeric Paraffin Composition RC2

A mixture (isomeric paraffin composition) comprising about 32 wt-% monomethyl substituted isoparaffins, about 16 wt-% multibranched isoparaffins, and about 52 wt-% n-paraffins was provided. The composition of the mixture was analyzed by GC analysis and the results are shown in Table 6. The composition corresponds to a hydrocarbon composition (diesel fraction) derived from a renewable feedstock which is subjected to hydrotreating and isomerization, but so that a composition having a higher degree (wt-% amounts) of both monomethyl substituted and multibranched isoparaffins than composition RC1 was obtained. The ratio of the wt-% amount of monobranched isoparaffins to the wt-% amount of multiple branched isoparaffins is 1.9 in composition RC2.

Renewable Isomeric Paraffin Composition RC3

A mixture (isomeric paraffin composition) comprising about 45 wt-% monomethyl substituted isoparaffins, about 44 wt-% multibranched isoparaffins, and about 11 wt-% n-paraffins was provided. The composition of the mixture was analyzed by GC analysis and the results are shown in Table 6. The composition corresponds to a hydrocarbon composition (diesel fraction) derived from a renewable feedstock which is subjected to hydrotreating and isomerization. The isomerization was performed so that a composition having a higher degree (wt-% amounts) of both monomethyl substituted and multibranched isoparaffins than compositions RC1 and RC2 was obtained. The ratio of the wt-% amount of monobranched isoparaffins to the wt-% amount of multiple branched isoparaffins is 1.0 in composition RC3.

TABLE 6
Composition of the renewable isomeric diesel samples

| | RC1 | | | RC2 | | | RC3 | | |
|---|---|---|---|---|---|---|---|---|---|
| | | iP | iP | | iP | iP | | iP | iP |
| Carbon number | nP | (mono) | (multi) | nP | (mono) | (multi) | nP | (mono) | (multi) |
| 2 | 0.00 | 0.00 | 0.00 | 0.00 | 0.00 | 0.00 | 0.00 | 0.00 | 0.00 |
| 3 | 0.00 | 0.00 | 0.00 | 0.00 | 0.00 | 0.00 | 0.00 | 0.00 | 0.00 |
| 4 | 0.00 | 0.00 | 0.00 | 0.00 | 0.00 | 0.00 | 0.00 | 0.00 | 0.00 |
| 5 | 0.00 | 0.00 | 0.00 | 0.01 | 0.00 | 0.00 | 0.00 | 0.00 | 0.00 |
| 6 | 0.01 | 0.00 | 0.02 | 0.02 | 0.00 | 0.02 | 0.01 | 0.00 | 0.02 |
| 7 | 0.04 | 0.00 | 0.09 | 0.06 | 0.00 | 0.10 | 0.04 | 0.00 | 0.09 |
| 8 | 0.10 | 0.00 | 0.26 | 0.10 | 0.00 | 0.20 | 0.10 | 0.00 | 0.26 |
| 9 | 0.03 | 0.00 | 0.06 | 0.13 | 0.00 | 0.26 | 0.20 | 0.00 | 0.65 |
| 10 | 0.06 | 0.00 | 0.07 | 0.14 | 0.00 | 0.34 | 0.28 | 0.00 | 1.40 |
| 11 | 0.05 | 0.02 | 0.02 | 0.16 | 0.23 | 0.14 | 0.28 | 1.12 | 0.84 |
| 12 | 0.12 | 0.03 | 0.02 | 0.22 | 0.26 | 0.19 | 0.25 | 1.14 | 1.12 |
| 13 | 0.36 | 0.05 | 0.02 | 0.29 | 0.29 | 0.23 | 0.24 | 1.16 | 1.27 |
| 14 | 1.25 | 0.13 | 0.04 | 0.66 | 0.49 | 0.31 | 0.47 | 1.55 | 1.63 |
| 15 | 4.95 | 0.43 | 0.17 | 7.03 | 3.93 | 1.62 | 1.31 | 4.39 | 3.52 |
| 16 | 16.72 | 1.02 | 0.62 | 16.75 | 9.65 | 4.20 | 2.27 | 9.06 | 8.03 |
| 17 | 15.42 | 1.38 | 0.74 | 7.93 | 5.76 | 2.78 | 2.26 | 10.44 | 8.68 |
| 18 | 47.79 | 2.31 | 2.32 | 17.87 | 10.74 | 5.47 | 3.04 | 15.16 | 15.66 |
| 19 | 0.50 | 0.16 | 0.18 | 0.12 | 0.17 | 0.12 | 0.06 | 0.37 | 0.37 |
| 20 | 0.95 | 0.07 | 0.08 | 0.18 | 0.14 | 0.09 | 0.07 | 0.38 | 0.40 |
| 21 | 0.08 | 0.03 | 0.04 | 0.02 | 0.03 | 0.03 | 0.01 | 0.05 | 0.04 |
| 22 | 0.17 | 0.03 | 0.03 | 0.03 | 0.03 | 0.02 | 0.01 | 0.06 | 0.05 |
| 23 | 0.04 | 0.01 | 0.01 | 0.02 | 0.02 | 0.01 | 0.00 | 0.01 | 0.01 |
| 24 | 0.07 | 0.01 | 0.01 | 0.03 | 0.02 | 0.01 | 0.00 | 0.01 | 0.01 |
| 25 | 0.03 | 0.00 | 0.00 | 0.00 | 0.00 | 0.00 | 0.00 | 0.00 | 0.00 |
| >C25 | 0.00 | 0.00 | 0.96 | 0.00 | 0.00 | 0.34 | 0.00 | 0.00 | 0.13 |
| Total | 88.73 | 5.67 | 5.40 | 51.74 | 31.77 | 16.49 | 10.91 | 44.91 | 44.18 |

In Table 6, iP(mono) denotes monobranched isoparaffins, iP(multi) denotes multiple branched isoparaffins, and nP denotes n-paraffins.

Pour Point Measurements

Pour point measurements of the renewable diesel samples (renewable isomeric paraffin compositions) RC1, RC2, and RC3 were carried out according to the ASTM D5950-14 standard and using an ISL CPP 5G analyzer. The measuring frequency was 3° C. The reported pour point temperatures are an average of three individual measurements.

Pour point is the temperature below which liquid loses its flow characteristics. Typical steam crackers do not have heated feedstock tanks or feed pipelines. Therefore, the pour point of the feedstock is an important factor in ensuring the operability of the crackers at all weather conditions. To ensure the operability of the cracker around the year in locations where the temperature changes with seasons, i.e. at cold temperatures, a feedstock having its pour point below 0° C. should be chosen.

Table 7 shows the pour point temperatures for the renewable diesel samples RC1, RC2, and RC3 having different n-paraffin contents. The pour points for the compositions RC1, RC2, and RC3 are 21° C., −3° C., and −42° C., respectively. As can be seen, a higher n-paraffins content results in a higher pour point temperature, and isomerization, i.e. a higher isomerization degree, improves the cold properties of the renewable isomeric paraffin composition. The high pour point of RC1 limits its use as feedstock for crackers without investments in feedstock logistics to locations with warm temperatures year round, i.e. locations, where the temperature does not significantly drop below 25° C. during any season.

TABLE 7
Measured pour points of RC1, RC2, and RC3

| Sample | Pour point (° C.) |
|---|---|
| RC1 | 21 |
| RC2 | −3 |
| RC3 | −42 |

### Example 1

Steam cracking was carried out in laboratory scale using composition RC3 at a temperature (coil outlet temperature, COT) of 780° C. and a dilution of 0.5 (flow rate ratio of water to isomeric paraffin composition RC3; water [kg/h]/RC3 [kg/h]) at 1.7 bar (absolute) in a 1.475 m long tubular reactor made of Incoloy 800HT™ steel (30-35 wt-% Ni, 19-23 wt-% Cr, >39.5 wt-% Fe) having an inner diameter of 6 mm. The renewable isomeric paraffin composition flow rate was fixed at 150 g/h. The coil outlet temperature (COT) was measured at a position 1.24 m downstream of the inlet of the reactor, which corresponds to the region having the highest temperature in the reactor.

The product mixture (mixture of biohydrocarbons) was analyzed by GC×GC, as mentioned above. The results of the effluent analysis are shown in Table 8.

### Examples 2 to 20

Steam cracking was carried out similar to Example 1, except for changing the renewable isomeric paraffin composition, COT and dilution, as indicated in Tables 8 and 9. The product mixtures (mixture of biohydrocarbons) were analyzed by GC×GC, as detailed above. The results of the effluent analyses are shown in Tables 8 and 9.

### Example 21

Steam cracking was carried out in pilot scale using composition RC1 at a temperature (coil outlet temperature, COT) of 820° C. and a dilution of 0.45 (flow rate ratio of water to composition RC1; water [kg/h]/RC1 [kg/h]) at 1.7 bar (absolute) in approximately 12.49 m long tubular reactor made of Incoloy 800HT™ (30-35 wt-% Ni, 19-23 wt-% CR, >39.5 wt-% Fe) having an inner diameter of 9 mm. The flow rate of composition RC1 was fixed at 3.6 kg/h. The product mixture (mixture of biohydrocarbons) was analyzed by GC×GC, as described above. The results of the effluent analysis are shown in Table 10.

### Examples 22 to 23

Steam cracking was carried out similar to Example 21, except for changing COT as indicated in Table 10. The product mixtures were analyzed by GC×GC, as described above. The results from the effluent analyses are shown in Table 10.

TABLE 8
Steam cracking conditions and effluent analysis results for examples 1-10

| Example # | 1 | 2 | 3 | 4 | 5 | 6 | 7 | 8 | 9 | 10 |
|---|---|---|---|---|---|---|---|---|---|---|
| Feedstock | RC3 | RC3 | RC3 | RC3 | RC3 | RC3 | RC3 | RC3 | RC3 | RC3 |
| COT (° C.) | 780 | 800 | 820 | 840 | 860 | 780 | 800 | 820 | 840 | 860 |
| Dillution | 0.5 | 0.5 | 0.5 | 0.5 | 0.5 | 0.35 | 0.35 | 0.35 | 0.35 | 0.35 |
| (gH2O/g iso-HC) | | | | | | | | | | |
| hydrogen | 0.43 | 0.52 | 0.58 | 0.68 | 0.8 | 0.47 | 0.57 | 0.67 | 0.73 | 0.85 |
| methane | 8.17 | 9.71 | 10.48 | 11.11 | 12.25 | 9.14 | 9.65 | 10.31 | 10.79 | 13.45 |
| ethene | 31.22 | 32.46 | 32.98 | 33.57 | 33.74 | 29.35 | 31.67 | 32.17 | 33.15 | 33.32 |
| propene | 23.06 | 23.1 | 20.47 | 18.16 | 13.97 | 21.85 | 21.71 | 18.99 | 16.28 | 13.39 |
| 1,3-butadiene | 5.27 | 6.13 | 6.17 | 5.8 | 4.44 | 5.02 | 5.52 | 5.31 | 4.23 | 3.94 |
| benzene | 2.09 | 3.31 | 5.03 | 6.59 | 8.26 | 3.29 | 4.14 | 7 | 7.85 | 9.19 |
| toluene | 0.98 | 1.45 | 2.03 | 2.34 | 2.66 | 1.63 | 1.89 | 2.5 | 2.78 | 3.06 |
| xylenes | 0.17 | 0.2 | 0.28 | 0.31 | 0.35 | 0.27 | 0.3 | 0.37 | 0.4 | 0.37 |
| others | 26.53 | 23.12 | 21.98 | 21.44 | 23.53 | 27.86 | 24.55 | 22.68 | 23.79 | 22.43 |
| C5+ total | 15.26 | 12.32 | 16.16 | 19.92 | 26.81 | 18.03 | 15.86 | 20.22 | 25.08 | 26.62 |
| BTX | 3.24 | 4.96 | 7.34 | 9.24 | 11.27 | 5.19 | 6.33 | 9.87 | 11.03 | 12.62 |
| HVC | 70.24 | 75.23 | 75.71 | 75.91 | 73.46 | 69.12 | 73.26 | 74.45 | 73.03 | 74.14 |
| ethene and propene | 54.28 | 55.56 | 53.45 | 51.73 | 47.71 | 51.2 | 53.38 | 51.16 | 49.43 | 46.71 |
| Unconverted Reactant | 2.08 | 0 | 0 | 0 | 0 | 1.12 | 0 | 0 | 0 | 0 |

TABLE 9
Steam cracking conditions and effluent analysis results for examples 11-20

| Example # | 11 | 12 | 13 | 14 | 15 | 16 | 17 | 18 | 19 | 20 |
|---|---|---|---|---|---|---|---|---|---|---|
| Feedstock | RC2 | RC2 | RC2 | RC2 | RC2 | RC2 | RC2 | RC2 | RC2 | RC2 |
| COT (° C.) | 780 | 800 | 820 | 840 | 860 | 780 | 800 | 820 | 840 | 860 |
| Dillution | 0.50 | 0.50 | 0.50 | 0.50 | 0.50 | 0.35 | 0.35 | 0.35 | 0.35 | 0.35 |
| (gH2O/g iso-HC) | | | | | | | | | | |
| hydrogen | 0.44 | 0.57 | 0.67 | 0.78 | 0.88 | 0.47 | 0.62 | 0.71 | 0.82 | 0.92 |
| methane | 7.00 | 8.65 | 10.19 | 11.96 | 12.86 | 8.46 | 10.32 | 11.15 | 14.36 | 15.00 |
| ethene | 31.95 | 35.67 | 37.34 | 39.04 | 39.55 | 32.57 | 35.03 | 36.25 | 38.14 | 39.46 |
| propene | 20.22 | 21.34 | 19.82 | 17.66 | 14.71 | 21.15 | 20.92 | 18.98 | 15.93 | 13.38 |
| 1,3-butadiene | 4.75 | 5.82 | 5.91 | 5.42 | 4.69 | 5.12 | 5.47 | 5.32 | 4.76 | 4.21 |
| benzene | 1.81 | 3.13 | 4.57 | 6.09 | 7.84 | 3.22 | 4.44 | 5.79 | 7.45 | 8.65 |
| toluene | 0.77 | 1.11 | 1.42 | 1.78 | 2.13 | 1.39 | 1.63 | 1.91 | 2.23 | 2.44 |
| xylenes | 0.10 | 0.15 | 0.18 | 0.20 | 0.25 | 0.15 | 0.22 | 0.25 | 0.29 | 0.34 |
| others | 26.21 | 22.42 | 19.50 | 16.95 | 17.09 | 25.93 | 21.24 | 19.54 | 16.02 | 15.60 |
| C5+ total | 22.16 | 14.80 | 14.82 | 15.69 | 19.39 | 17.76 | 13.67 | 16.05 | 16.41 | 18.31 |
| BTX | 2.68 | 4.39 | 6.17 | 8.07 | 10.22 | 4.76 | 6.29 | 7.95 | 9.97 | 11.43 |
| HVC | 66.17 | 75.18 | 78.50 | 80.95 | 80.53 | 70.99 | 76.80 | 78.20 | 81.46 | 81.62 |
| ethene and propene | 52.17 | 57.01 | 57.16 | 56.7 | 54.26 | 53.72 | 55.95 | 55.23 | 54.07 | 52.84 |
| unconverted reactant | 6.75 | 1.14 | 0.40 | 0.12 | 0 | 1.54 | 0.11 | 0.10 | 0 | 0 |

TABLE 10
Steam cracking conditions and effluent
analysis results for examples 21-23

| Example # | 21 | 22 | 23 |
|---|---|---|---|
| Feedstock | RC1 | RC1 | RC1 |
| COT (° C.) | 820 | 835 | 850 |
| Dilution (kgH2O/kg iso-HC) | 0.45 | 0.45 | 0.45 |
| hydrogen | 0.61 | 0.68 | 0.77 |
| methane | 10.31 | 11.47 | 12.55 |
| ethene | 37.39 | 38.52 | 39.51 |
| propene | 18.82 | 17.4 | 15.75 |
| 1,3-butadiene | 7.32 | 6.87 | 6.27 |
| benzene | 3.14 | 5.49 | 6.07 |
| toluene | 0.86 | 1.48 | 1.12 |
| xylenes | 0.43 | 0.67 | 0.5 |
| others | 21.12 | 17.42 | 17.46 |
| C5+ total | 14.5 | 15.7 | 16.64 |
| BTX | 4.43 | 7.64 | 7.69 |
| HVC | 77.59 | 80.43 | 80.92 |
| ethene and propene | 56.21 | 55.92 | 55.26 |
| unconverted reactant | 0 | 0 | 0 |

Ethene and propene are valuable products from a steam cracker. Hence, improving their combined yield improves the overall profitability of the cracking process. As can be seen in tables 8 to 10, a combined ethene and propene yield well above 50 wt-% is obtained with all compositions RC1, RC2, and RC3 at several COTs and dilutions.

As can be seen from the tables 8 to 10, the highest combined ethene and propene yield of the Examples is obtained with composition RC2 at a wide COT range, 780 to 860° C., particularly in the COT range 800° C. to 840° C. The highest combined yield of 57.16 wt-% is reached at COT of 820° C. Composition RC2 is moderately isomerized containing 32 wt-% monomethyl substituted isoparaffins, and 16 wt-% multibranched isoparaffins, the n-paraffins content of RC2 being 52 wt-%. RC2 also has the highest ratio of the wt-% amount of monomethyl substituted isoparaffins to the wt-% amount of multiple branched isoparaffins of compositions RC1, RC2, and RC3, said ratio of RC2 being 1.9. Surprisingly, highly isomerized RC3 samples with n-paraffins content of 11 wt-% and monomethyl substituted iso-paraffins content of 45 wt-% give substantially lower combined ethylene and propylene yields. The combined ethylene and propylene yield is also lower for RC1 sample with high n-paraffinic content.

The foregoing description has provided by way of non-limiting examples of particular implementations and embodiments of the invention a full and informative description of the best mode presently contemplated by the inventors for carrying out the invention. It is however clear to a person skilled in the art that the invention is not restricted to details of the embodiments presented in the foregoing, but that it can be implemented in other embodiments using equivalent means or in different combinations of embodiments without deviating from the characteristics of the invention.

Furthermore, some of the features of the afore-disclosed embodiments of this invention may be used to advantage without the corresponding use of other features. As such, the foregoing description shall be considered as merely illustrative of the principles of the present invention, and not in limitation thereof. Hence, the scope of the invention is only restricted by the appended patent claims.

1. A method for producing a mixture of biohydrocarbons containing propene and ethene, the method comprising:
(a) providing a renewable isomeric paraffin composition containing monobranched isoparaffins and multiple branched isoparaffins, a ratio of a wt-% amount of the monobranched isoparaffins to a wt-% amount of the multiple branched isoparaffins being at least 1; and
(b) thermally cracking said renewable isomeric paraffin composition to produce a mixture of biohydrocarbons containing propene and ethene.

2. The method according to claim 1, wherein providing the renewable isomeric paraffin composition comprises:
(i) preparing a hydrocarbon raw material from a renewable feedstock; and
(ii) subjecting at least straight chain hydrocarbons in the hydrocarbon raw material to an isomerization treatment to prepare the renewable isomeric paraffin composition,
wherein subjecting at least straight chain hydrocarbons in the hydrocarbon raw material to an isomerization treatment includes controlling production of monobranched and multiple branched isoparaffins during the isomerization treatment.

3. The method according to claim 1, wherein a pour point of the renewable isomeric paraffin composition is below 0° C., and wherein combined wt-% amounts of the monobranched isoparaffins and the multiple branched isoparaffins in the renewable isomeric paraffin composition is at least 45 wt-%.

4. The method according to claim 1, wherein the ratio of the wt-% amount of the monobranched isoparaffins to the wt-% amount of the multiple branched isoparaffins is at least 1.25.

5. The method according to claim 1, wherein the renewable isomeric paraffin composition contains less than 40 wt % multiple branched isoparaffins.

6. The method according to claim 1, wherein the renewable isomeric paraffin composition contains at least 90 wt-% paraffins.

7. The method according to claim 1, wherein the mixture of biohydrocarbons contains more than 45 wt % propene and ethene combined.

8. The method according to claim 1, wherein thermally cracking said renewable isomeric paraffin composition is conducted at a coil outlet temperature (COT) selected from a range from 780° C. to 890° C.

9. The method according to claim 2, wherein preparing a hydrocarbon raw material comprises
subjecting the renewable feedstock to a deoxygenation treatment; and/or hydrocracking hydrocarbons in the hydrocarbon raw material.

10. The method according to claim 1, wherein the renewable isomeric paraffin composition contains at least one of a diesel range fraction and a naphtha range fraction, and the method comprises:
subjecting the diesel range fraction and/or the naphtha range fraction to thermally cracking of said renewable isomeric paraffin composition to produce a mixture of biohydrocarbons containing propene and ethene.

11. The method according to claim 1, wherein the renewable isomeric paraffin composition is selected from one of fractions A and B, wherein:
fraction A contains more than 50 wt-% C10-C20 hydrocarbons, and the fraction A contains at most 1.0 wt-% aromatics, and less than 2.0 wt-% naphthenes; and
fraction B contains more than 50 wt-% C5-C10 hydrocarbons, and the fraction B contains at most 1.0 wt-% aromatics, and less than 2.0 wt-% olefins, and at most 5.0 wt-% naphthenes.

12-17. (canceled)

18. The method according claim 1, wherein thermally cracking said renewable isomeric paraffin composition comprises:
steam cracking.

19. The method according claim 18, comprising:
performing the steam cracking at a flow rate ratio between water and the renewable isomeric paraffin composition (H₂O flow rate [kg/h]/iso-HC flow rate [kg/h]) of 0.05 to 1.20.

20. A renewable isomeric paraffin composition for producing a mixture of biohydrocarbons containing propene and ethene by thermal cracking, wherein the renewable isomeric paraffin composition comprises:
monobranched isoparaffins and multiple branched isoparaffins; and
wherein a ratio of a wt-% amount of the monobranched isoparaffins to a wt-% amount of the multiple branched isoparaffins is at least 1.

21. The renewable isomeric paraffin composition according to claim 20, wherein a combined wt-% amount of the monobranched isoparaffins and the multiple branched isoparaffins in the renewable isomeric paraffin composition is at least 45 wt-%, and wherein a pour point of the renewable isomeric paraffin composition is below 0° C.

22. The renewable isomeric paraffin composition according to claim 20, wherein the renewable isomeric paraffin composition comprises:
less than 40 wt-% multiple branched isoparaffins.

23. The renewable isomeric paraffin composition according to claim 20, wherein the renewable isomeric paraffin composition comprises:
at least 90 wt-% paraffins.

24. A mixture of biohydrocarbons containing propene and ethene, produced by the method according to 1.

25. The method according to claim 1, comprising:
producing chemicals and/or polymers using the mixture of biohydrocarbons.
